(19) United States
(12) Patent Application Publication
(10) Pub. No.: US 2010/0017630 A1
(43) Pub. Date: Jan. 21, 2010

(54) POWER CONTROL SYSTEM OF A HIGH DENSITY SERVER AND METHOD THEREOF

(76) Inventors: Chih-Wei CHEN, Taipei City (TW); Hsiao-Fen Lu, Taipei City (TW)

Correspondence Address: BRIAN M. MCINNIS, 12th Floor, Ruttonjee House, 11 Duddell Street, Hong Kong, HK

(21) Appl. No.: 12/239,065

(22) Filed: Sep. 26, 2008

(30) Foreign Application Priority Data
Jul. 17, 2008 (TW) 97127203

(51) Int. Cl. G06F 1/00

(52) U.S. Cl. 713/300

(57) ABSTRACT

A power control system of a server system is described. The power control system includes a plurality of server motherboards, a power supply and a micro controller. Each server motherboard comprises a BIOS, a power switch and a baseboard management controller (BMC), wherein each power switch is operable to selectively switch on or switch off a power supplying of each corresponding server motherboard, and each BMC is operable to output a status order in response to a control information of each corresponding BIOS. The power supply is electrically connected to all the power switches of all the server motherboards and operable to supply power to all the server motherboards. The micro controller is electrically connected to all the BMCs and operable to order the power switches to selectively switch on or switch off a power supplying of each corresponding server motherboard in response to the status order.

### RELATED APPLICATIONS

This application claims priority to Taiwan Application Serial Number 97127203, filed Jul. 17, 2008, which is herein incorporated by reference.

### BACKGROUND

1. Field of Invention

The present invention relates to a power control system of a high density server and method thereof. More particularly, the present invention relates to a power control system of a high-performance computing system and method thereof.

2. Description of Related Art

A high-density server system is a computing system, which has several independently operable server motherboards housed in one casing, and CPUs, cooling fans and other components on each server motherboard share a common power supply. As illustrated in FIG. 1, a conventional high-density server system 10 includes a power supply 20, which provides power to every server motherboard (11˜1n) via a corresponding power switch (111˜1n1). In case all server motherboards (11˜1n) are requested to boot simultaneously, all components on the all server motherboards (11˜1n) needs to be supplied with power at almost the same time. Thus, the power supply 20 needs to provide enough power for such huge power-consuming. Owing to such demands, the conventional power supply 20 is equipped with a large power capacity to satisfy the power-consuming for simultaneously booting all server motherboards. However, such large power capacity would be rarely used during normal operation after server motherboard (11˜1n) being booted.

For the forgoing reasons, there is a need for improving the conventional high-density server system.

### SUMMARY

It is therefore an objective of the present invention to provide a power control system of a high density server and method thereof.

In accordance with the foregoing and other objectives of the present invention, a power control system of a server system having a plurality of child servers is provided. The power control system includes a plurality of server motherboards, a power supply and a micro controller. Each server motherboard comprises a BIOS, a power switch and a baseboard management controller (BMC), wherein each power switch is operable to selectively switch on or switch off a power supplying of each corresponding server motherboard, and each BMC is operable to output a status order in response to a control information of each corresponding BIOS. The power supply is electrically connected to all the power switches of all the server motherboards and operable to supply power to all the server motherboards. The micro controller is electrically connected to all the BMCs and operable to order the power switches to selectively switch on or switch off a power supplying of each corresponding server motherboard in response to the status order.

In accordance with the foregoing and other objectives of the present invention, a power control method for a server system includes following steps. A micro controller is requested booting a plurality of server motherboards. Judging whether or not either one of server motherboards being booting. The server motherboards, requesting for booting but not being booted, are controlled to wait for booting. The micro controller is informed once either one of server motherboards is booted. Judging whether or not one of server motherboards requesting for booting but not being booted. The one of server motherboards, requesting for booting but not being booted, is supplied with power for booting.

Thus, the present invention provides a power control system of a high density server and method thereof, which includes a micro controller to have some of the server motherboards to boot instead of booting all the server motherboards simultaneously such that the power supply is not necessarily equipped with a large power capacity. In addition, the power control system also distribute power capacity properly in response to current resource such that the booted server motherboard would not be disturbed by serially booting server motherboards one after another.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a block diagram of a conventional high-density server system;

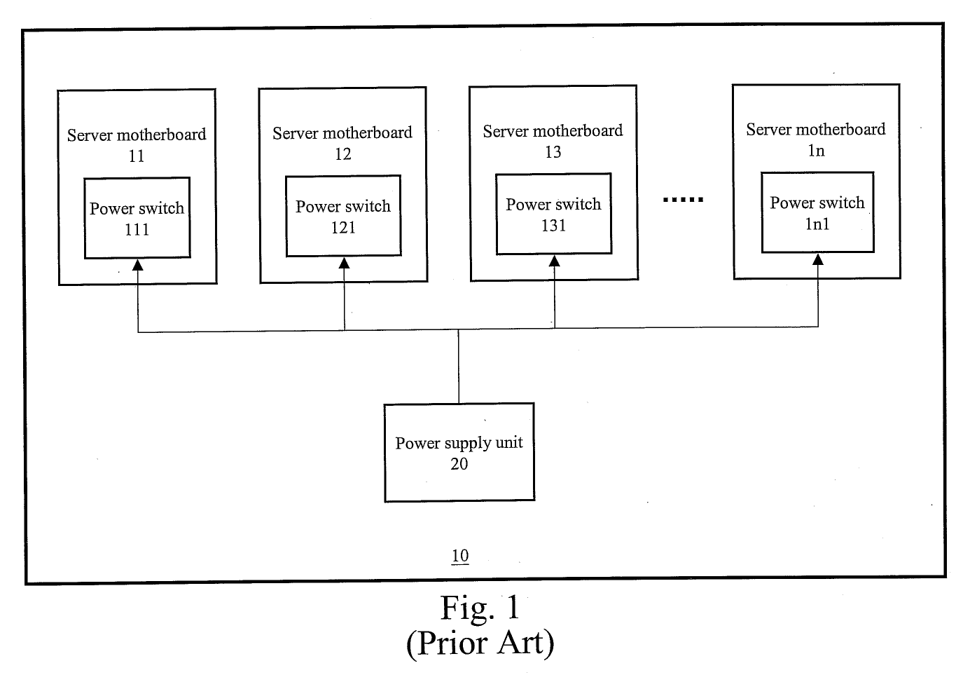

FIG. 2 illustrates a block diagram of a high-density server system according to one preferred embodiment of this invention; and

FIG. 3 illustrates a power control flow chart for a high-density server system according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

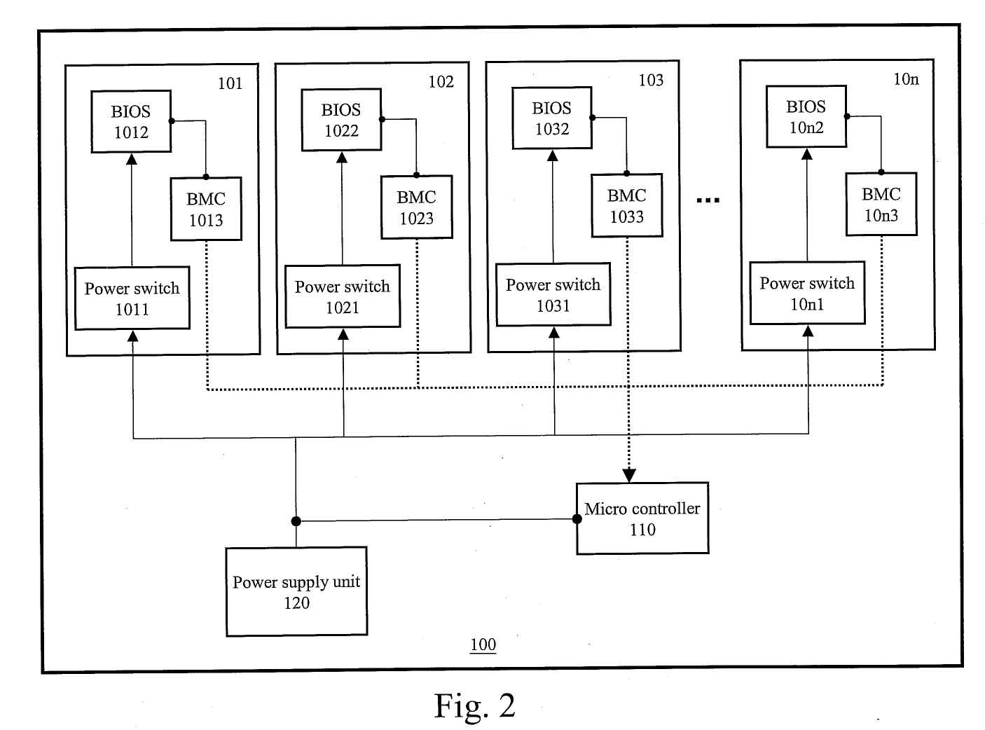

FIG. 2 illustrates a block diagram of a high-density server system according to one preferred embodiment of this invention. The high-density server system 100 includes multiple server motherboards (101˜10n), a power supply 120 and a micro controller 110. All server motherboards (101˜10n) are of the same hardware specifications, i.e. same computing capacity and same memory capacity, and operable independently from one another. Each server motherboards 10n has at least one BIOS (Basic Input Output System) 10n2, a power switch 10n1 and a BMC (Baseboard Management Controller) 10n3. The power switches (1011˜10n1) are operable for selectively switching on or switching off power supplying (provided by the power supply 120) to corresponding server motherboards (101˜10n). BMCs (1013˜10n3) are operable for outputting a status order in response to control information of BIOS (1012˜10n2). The power supply 120 is electrically connected all power switches (1011˜10n1) in order to provide power to all server motherboards (101˜10n) via each corresponding power switch (1011˜10n1). The power supply 120 may be defined to provide power to a maximum quantity, i.e. two, three or four, of the server motherboards 10n to boot simultaneously according to the power supply limit of the power supply 120 and the maximum power-consuming of a single server motherboard. The micro controller 110 is lo electrically connected to all BMCs (1013˜10n3) to receive the order status from all BMCs (1013˜10n3) and to order power switches (1011˜10n1) to switch on or switch off power supplying (to server motherboards 101˜10n) in response to the received order status.

The control information is a signal transmitted by an Intelligent Platform Management Interface (IPMI) interconnected between the BIOS and the BMC, i.e. the signal is from BIOS to BMC. The order status is a signal transmitted by an Intelligent Platform Management Bus (IPMB) interconnected between the BMC and the micro controller, the signal is from the BMC to the micro controller. The order status may include several type of statuses including “the server motherboard 10n being booting, i.e. all components being initialized and operation system (software) being loading into the components”, “the server motherboard 10n being normally operating after being booted, i.e. operation system (software) has been loaded into the components and can be executed” and “the server motherboard being shut down, i.e. operation system (software) being terminated and the components being cut off power”. In case the micro controller 110 is informed that the server motherboard 101 is of the order status “the server motherboard being booting”, the power switch 1011 of the server motherboard 101 is ordered to switch on power supplying by the micro controller 110, and the power switches (1021˜10n1) of the remaining server motherboards (102˜10n), requesting for booting but not being booted, are ordered to switch off power supplying (to the server motherboards (102˜10n) by the micro controller 110. In case the micro controller 110 is informed that the server motherboards (101, 102) is of the order status “the server motherboard being operating after being booted”, the power switches (1011, 1021) of the server motherboards (101, 102) are ordered to switch on power supplying by the micro controller 110, and either one (1031) of the power switches (1031˜10n1) of the remaining server motherboards (103˜10n), requesting for booting but not being booted, is ordered to switch on power supplying (to the server motherboard 103) by the micro controller 110. In case the micro controller 110 is informed that the server motherboard 104 is of the order status “the server motherboard being shut down”, the power switch 1041 of the server motherboard 104 is ordered to switch off power supplying (to the server motherboard 104) by the micro controller 110.

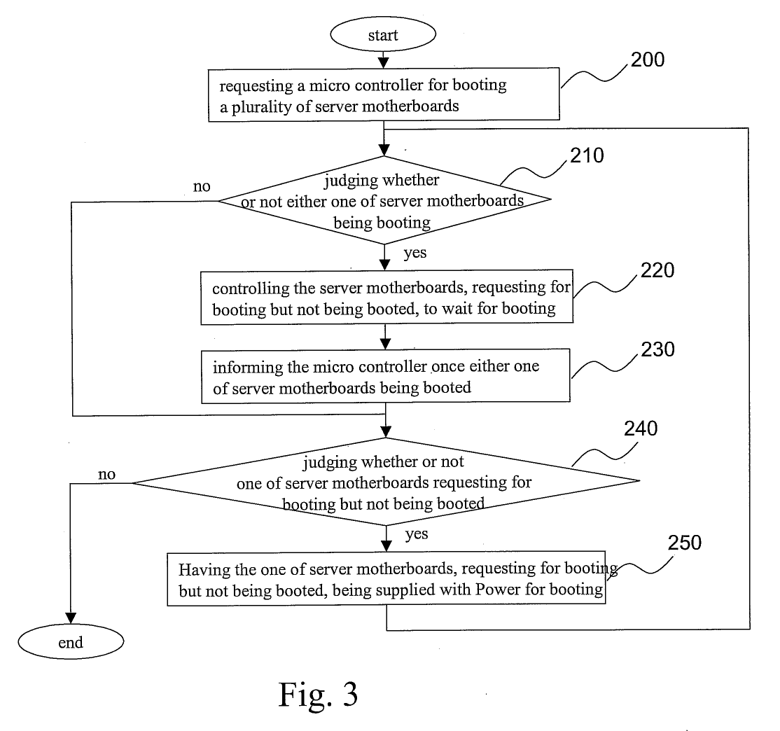

FIG. 3 illustrates a power control flow chart for a high-density server system according to one preferred embodiment of this invention. In step “200”, a micro controller 110 is requested to boot a plurality of server motherboards (101˜10n). In step 210, the micro controller 110 is utilized to judge whether or not either one of server motherboards being booting. In case the server motherboard 101 is booting, the remaining server motherboards (102˜10n), requesting for booting but not being booted, are ordered to wait for booting (step 102). In case there is no server motherboard being booting in step 210, go directly to step 240. After step “220”, the micro controller is informed after the server motherboard 101 has been booted (step 230). In case there are other server motherboards (102˜10n), requesting for booting but not being booted, in step “240”, either one (such as the server motherboard 102) of server motherboards, requesting for booting but not being booted, is supplied with power for booting (step 250) and the procedure goes back step 210 to judge whether or not either one of server motherboards being booting. In case there is no server motherboard, requesting for booting but not being booted, all server motherboards (101˜10n) have been booted and the procedure ends.

Step 210 and step 240 are both executed by the micro controller 110 to receive a signal transmitted by an Intelligent Platform Management Bus (IPMB) interconnected between the BMC (1012˜10n2) and the micro controller 110, the signal is from the BMC to the micro controller. Step 220 is executed by the micro controller 110 to have the power switches (1021˜10n1) of the server motherboards (102˜10n), requesting for booting but not being booted, to switch off power supplying. Step 250 is executed by the micro controller 110 to have either one (such as the power switch 10n1) of the power switches of the server motherboards, requesting for booting but not being booted, to switch on power supplying (to the server motherboard 10n).

According to discussed embodiments, the present invention provides a power control system of a high density server and method thereof, which includes a micro controller to have some of the server motherboards to boot instead of booting all the server motherboards simultaneously such that the power supply is not necessarily equipped with a large power capacity. In addition, the power control system also distribute power capacity properly in response to current resource such that the booted server motherboard would not be disturbed by serially booting server motherboards one after another.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A power control system of a server system comprising:
a plurality of server motherboards each comprises a BIOS (Basic Input Output System), a power switch and a BMC (baseboard management controller), wherein each power switch is operable to selectively switch on or switch off a power supplying of each corresponding server motherboard, and each BMC is operable to output a status order in response to a control information of each corresponding BIOS;
a power supply being electrically connected to all the power switches of all the server motherboards and operable to supply power to all the server motherboards; and
a micro controller being electrically connected to all the BMCs and operable to order the power switches to selectively switch on or switch off a power supplying of each corresponding server motherboard in response to the status order.

2. The power control system of claim 1, wherein the server motherboards are of the same hardware specifications.

3. The power control system of claim 1, wherein the server motherboards are operable independently from one another.

4. The power control system of claim 1, wherein the control information is the signal transmitted by an Intelligent Platform Management Interface interconnected between the BIOS and the BMC.

5. The power control system of claim 1, wherein the order status is the signal transmitted by an Intelligent Platform Management Bus interconnected between the BMC and the micro controller.

6. The power control system of claim 1, wherein the order status comprises the server motherboard being booting, the server motherboard being operating after being booted or the server motherboard being shut down.

7. The power control system of claim 6, wherein when one server motherboard is of the order status “the server motherboard being booting”, the power switch of the server motherboard being ordered to switch on power supplying by the micro controller, and the power switches of the remaining server motherboards, requesting for booting but not being booted, being ordered to switch off power supplying by the micro controller.

8. The power control system of claim 6, wherein when one server motherboard is of the order status “the server motherboard being operating after being booted”, the power switch of the server motherboard being ordered to switch on power supplying by the micro controller, and either one of the power switches of the remaining server motherboards, requesting for booting but not being booted, being ordered to switch on power supplying by the micro controller.

9. The power control system of claim 6, wherein when one server motherboard is of the order status “the server motherboard being shut down”, the power switch of the server motherboard being ordered to switch off power supplying by the micro controller.

10. The power control system of claim 1, wherein the power supply being operable to supply a maximum power for only one server motherboard being booting.

11. A power control method for a server system comprising the following steps:
(a) requesting a micro controller for booting a plurality of server motherboards;
(b) judging whether or not either one of server motherboards being booting;
(c) controlling the server motherboards, requesting for booting but not being booted, to wait for booting;
(d) informing the micro controller once either one of server motherboards being booted;
(e) judging whether or not one of server motherboards requesting for booting but not being booted; and
(f) having the one of server motherboards, requesting for booting but not being booted, being supplied with power for booting.

12. The power control method of claim 11, wherein the server motherboards are of the same hardware specifications.

13. The power control method of claim 11, wherein the server motherboards are operable independently from one another.

14. The power control method of claim 11, wherein the step (b) and the step (e) are executed by a micro controller in response to a status order of a baseboard management controller on the server motherboard.

15. The power control method of claim 14, wherein the status order is transmitted by an Intelligent Platform Management Bus interconnected between the BMC and the micro controller.

16. The power control method of claim 11, wherein the step (c) is executed by a micro controller to have the power switches of the server motherboards, requesting for booting but not being booted, to switch off power supplying.

17. The power control method of claim 11, wherein the step (f) is executed by a micro controller to have the one of the power switches of the server motherboard, requesting for booting but not being booted, to switch on power supplying.

18. The power control method of claim 11, wherein a maximum power supply for the server motherboards is the amount of power for only one server motherboard being booting.
